(19) United States
(12) Patent Application Publication
(10) Pub. No.: US 2025/0299481 A1
(43) Pub. Date: Sep. 25, 2025

(54) Methods and Systems for Enhanced Automated Reading of an Analog Gauge

(71) Applicant: Levatas, Inc., West Palm Beach, FL (US)

(72) Inventors: Joshua B. Albert, Boynton Beach, FL (US); David W. Newmon, Loxahatchee, FL (US); Christopher S. Nielsen, Jupiter, FL (US)

(73) Assignee: Levatas, Inc., West Palm Beach, FL (US)

(21) Appl. No.: 19/085,851

(22) Filed: Mar. 20, 2025

Related U.S. Application Data
(60) Provisional application No. 63/567,564, filed on Mar. 20, 2024.

(51) Int. Cl. G06V 10/98; G06V 10/72; G06V 10/94; G06V 20/56

(52) U.S. Cl. CPC G06V 10/993; G06V 10/72; G06V 10/945; G06V 20/56; G06V 2201/02

(57) ABSTRACT

Provided herein is a method for enhanced automated reading of an analog gauge, the method including: obtaining a reading image of a target gauge, obtaining or creating a template configuration corresponding to the target gauge, processing the reading image relative to the corresponding template configuration, determining any irregularity in the reading image, and compensating for the determined irregularity. Also provided are systems for creating a template configuration for use in enhancing an automated reading of a target gauge value.

### CROSS-REFERENCE TO RELATED APPLICATION

This application claims priority to U.S. Provisional Application Ser. No. 63/567,564, filed Mar. 20, 2024, the entire contents of which are incorporated herein by reference.

### TECHNICAL FIELD

The present disclosure relates to the fields of instrumentation, data science, and computer vision. Specifically, this disclosure relates to reading an analog gauge.

### BACKGROUND

Analog gauges (metric devices for measuring, e.g., one or more of pressure, temperature, speed, angle, and force) are used frequently in industrial settings. Tracking data from these gauges may be desirable for optimizing processes, and/or for identifying anomalies and adjusting/repairing equipment to avoid breakdowns. Collecting gauge data in a digital form, however, is typically expensive or even impossible. Gathering frequent readings is inefficient and adds expense since manually reading gauges is time consuming and tedious. Replacing analog gauges with digital gauges capable of automatically transmitting readings to a central database is very expensive and/or may be disruptive to the overall functionality. One solution known in the art includes mounting cameras to gauge faces; however, this may occlude the gauge face and often requires extensive wiring additions. Processing images of analog gauges in industrial environments by existing gauge reading software is also problematic. The images are typically out of focus or taken from an angle other than straight-on, which causes parallax errors in the apparent reading. Further, gauges may be dirty, partially obscured or contain multiple scales which may confuse software attempting to read gauge images.

Thus, methods and systems for improved automated gauge reading are desired in the art.

### SUMMARY

Accordingly, the present disclosure provides efficient and reliable methods and systems for improving accuracy in automated reading of analog gauges.

According to one embodiment, methods comprise obtaining a reading image of a target gauge, obtaining or creating a template configuration corresponding to the target gauge, processing the reading image relative to the corresponding template configuration, determining any irregularity in the reading image, and compensating for a determined irregularity.

According to other embodiments, systems for creating a template configuration for use in enhancing an automated reading of a target gauge value are provided. According to one embodiment, a system comprises a computer comprising a computer-user interface, a template image of a target gauge accessible to the user at the interface, the template image comprising associated data, a computer-executable algorithm for a set of queries prompting the user to enter input data at the interface, and a computer-executable algorithm for creating a template configuration from the associated data and the input data. In embodiments, associated data may include, but is not limited to, image data, image metadata, such as date/time of the image, geolocation data of the image, file name, file format, image dimensions, and/or information pertaining to the camera that capture the image data. In embodiments, input data comprises data input by a user and may include, but is not limited to, identification of which gauge in an image is relevant, for example, if more than one image is visible, identifying the pixel nearest the center of the gauge, identifying the angles associated with one or more reading values, information pertaining to the colors of the gauge needle, the color of the background of the gauge, information on the range of readings that are considered normal for that gauge, and the like. Another embodiment is directed to a system for processing a read image for use in enhancing an automated reading of a target gauge value. The system comprises at least one image-capturing device positioned to capture at least one reading image of a target gauge, a computer for receiving a captured image of a target gauge, a database comprising accessible template configurations, and a computer-executable algorithm for processing a reading image of a target gauge relative to its corresponding template configuration, wherein processing determines any irregularities in the reading image which may be compensated to yield a corrected reading value.

Additional features and advantages of the embodiments described herein will be set forth in the detailed description that follows, and in part will be readily apparent to those skilled in the art from that description or recognized by practicing the embodiments described herein, including the detailed description that follows, the claims, as well as the appended drawings.

### BRIEF DESCRIPTION OF THE DRAWINGS

FIG. 1 illustrates an embodiment wherein QR codes may identify gauges via proximity to the upper-right region of a gauge.

FIGS. 2A-2F illustrate a parallax correction according to embodiments of the invention. FIG. 2A illustrates a gauge having a needle as viewed from a straight-on angle perspective; FIG. 2B illustrates (viewed from above) an observer reading a gauge from a straight-on angle perspective; FIG. 2C illustrates the same gauge having a needle as viewed from an angle; FIG. 2D illustrates (viewed from above) an observer reading the gauge from an angle; FIG. 2E illustrates the gauge having a needle with a parallax-corrected needle determined by methods according to the invention; and FIG. 2F illustrates an embodiment (viewed from above) wherein an observer using a device comprising a camera reading the gauge from an angle such that the reading may be corrected.

FIGS. 3A-3B illustrate an exemplary transformed image annotation. FIG. 3A illustrates a transformed gauge image; and FIG. 3B illustrates exemplary annotation for the reading of the transformed gauge image.

FIG. 4 sets forth a flowchart depicting exemplary embodiments of creating a template configuration, reading an analog gauge, and logging results.

FIG. 5 sets forth a flowchart depicting an exemplary embodiment of creating a template configuration.

FIG. 6 sets forth a flowchart depicting an exemplary partially automated methods of creating a template configuration.

FIG. 7 sets forth a flowchart depicting an exemplary embodiment of reading a gauge without requiring manually creating a template configuration.

### DETAILED DESCRIPTION

The details of embodiments of the presently-disclosed subject matter are set forth in this document. Modifications to embodiments described in this document, and other embodiments, will be evident to those of ordinary skill in the art after a study of the information provided in this document.

While the following terms are believed to be well understood in the art, definitions are set forth to facilitate explanation of the presently-disclosed subject matter. Unless defined otherwise, all technical and scientific terms used herein have the same meaning as commonly understood by one of ordinary skill in the art to which the presently-disclosed subject matter belongs.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used in this specification and the appended claims, the singular forms “a,” “an” and “the” include plural references unless the content clearly dictates otherwise.

Analog gauge, as used herein, refers to any device that uses the rotation angle of at least one pointing object (e.g. “needle”) to indicate a measurement. An analog gauge typically comprises at least one face comprising at least one “pivot”-a point around which a needle rotates. Commonly, a pivot is located near the center of a face; however, methods according to the invention are applicable to gauges comprising an off-center pivot or wherein the pivot point is partially or fully obscured by, for example, an opaque or translucent casing. A needle may be entirely visible or may be partially obscured. There may be more than one needle, typically distinguished by color, size, or design.

QR Code or Quick-Response code, as used herein, refers to a specific type of 2-dimensional matrix barcode comprising an array of black and white squares.

Template configuration, as used herein, refers to a collection of data (optionally combined into a single computer file), which includes a template image of a gauge to be read.

Template image, as used herein, refers to a best-available image of an analog gauge, ideally with a straight-on perspective.

Robotic unit, as used herein, refers to a device capable of moving at least one part or aspect up to the entire device, which is referred to herein as a mobile robotic unit.

Reading image, as used herein, refers to an image of an analog gauge captured in order to determine the gauge's reading, as indicated by needle position, at the time of image capture.

Irregularity (on the reading image), as used herein, refers to any deficiency of the reading image which makes determining the gauge measurement difficult. Irregularities include, without limitation, parallax error, poor focus, partial obscuration of the gauge, and other similar issues.

OCR or Optical Character Recognition, as used herein, refers to a computer program for detecting the location of and content of text in an image.

Straight-on, as used herein, refers to a preferred perspective for reading an analog gauge. A viewpoint location or camera lies on a line perpendicular to a gauge face and in-line with a pivot point of the gauge, and the view or camera is directed so the gauge is near the center of the field of view.

Tick-mark plate, as used herein, refers to a flat or substantially planar surface on which tick marks and other indications of how needle direction correspond to measurement are printed or etched.

SIFT or Scale-Invariant Feature Transform, as used herein, refers to a feature detector algorithm.

SURF or Speeded Up Robust Features, as used herein, refers to a feature detector algorithm.

CLIP or Contrastive Language-Image Pretraining, as used herein, refers to a method developed by OpenAI.

OpenCV, as used herein, refers to an open-source online computer vision library.

BRIEF or Binary Robust Independent Elementary Features, as used herein, refers to a feature-descriptor method.

ORB or Oriented FAST and Rotated BRIEF, as used herein, refers to a combination key point detector and descriptor, available in OpenCV.

The present disclosure provides novel methods and systems for improving accuracy in automated reading of analog gauges.

According to some embodiments, methods for reading an analog gauge comprise detecting one or more analog gauges and providing a corresponding template configuration for each detected gauge.

According to one embodiment a method comprises obtaining a reading image of a target gauge, obtaining or creating a template configuration corresponding to the target gauge, processing the reading image relative to the corresponding template configuration, determining any irregularity in the reading image, and compensating for a determined irregularity. According to specific embodiments, processing the reading image comprises computing a perspective transform on the reading image. According to more specific embodiments the perspective transform comprises a homographic perspective transform. In very specific embodiments, a determined irregularity comprises a parallax error. According to some embodiments a step of determining an irregularity comprises processing data from the template configuration and a transformed reading image. Compensating for a determined irregularity may comprise estimating one or more of a corrected reading, an uncertainty on the corrected reading, and a confidence value for the corrected reading. According to some embodiments data and/or metadata associated with a target image is added to the template configuration.

According to some embodiments, obtaining a reading image comprises capturing an image of the target gauge with one or more image-capturing devices. In specific embodiments, one or more image-capturing devices comprises a digital camera. In some specific embodiments one or more image-capturing devices are mounted on a robotic unit and in a very specific embodiment the robotic unit comprises a mobile robotic unit.

According to some embodiments a reading image of a gauge is received at a processing device such as a computer, and the received reading image is processed relative to its corresponding template configuration. In some specific embodiments the methods further comprise transmitting a reading image to a database. In very specific embodiments transmitting comprises logging into a database and in other very specific embodiments transmitting comprises automated transfer into a database. Database, as used herein comprises structured information including, for example, a data file. According to some embodiments methods further comprise generating one or more alerts if a reading deviates from an expected reading.

According to one embodiment, a template configuration (also referred to herein as a “template”) corresponding to an analog gauge is provided for enhanced gauge reading. This allows more accurate reading of gauges, especially if the reading is not taken from a straight-on angle perspective. In some embodiments, providing a template configuration comprises obtaining an existing straight-on angle image of a target gauge (a gauge for which a reading is desired), and in some embodiments providing a template configuration comprises creating a template configuration. A template configuration may be used for reading any analog gauge of substantially identical design. In specific embodiments, at least one template configuration is obtained or created for each target gauge.

A template image of a gauge to be read may be created, for example using an image-capturing device, or obtained, for example, from high-fidelity marketing or instructional material or from at least one previously created template. According to preferred embodiments, the template image of the gauge to-be-read comprises a straight-on angle perspective image. A template image should be substantially free of dirt or glare or defects incident to the gauge cover, for example reflections from the gauge glass. An operational image of a target gauge is referred to herein as a reading gauge image.

In some embodiments, a template image may be modified for better processing performance. Examples of image modifications comprise one or more of resizing, cropping, denoising, enhancing or otherwise modifying contrast, color-based smoothing, rotating, stretching, skewing, and blurring. Other exemplary suitable image modifications comprise processing operations such as perspective transformations and custom or common machine learning image enhancement techniques, such as techniques used to enhance text in images.

In some embodiments a captured image is converted into a template file (a computer file containing necessary template information) using computer-readable gauge templating media comprising computer-executable instructions, for example, software. Computer-executable instructions may be run on a user's computer, on a cloud hosted platform accessible by a user, or on a robotic device accessible by a user, or elsewhere. It is contemplated as within the scope of the disclosure that a template file may be manually assembled by combining a template configuration with other images and data (as set forth in detail herein) stored in a convenient format such as json or yaml, and/or optionally encapsulated and/or stored in an archive file format such as zip, rar, tar, or another suitable format apparent to one of skill in the art.

Information/data may be determined from a gauge template image either automatically via computer readable media and/or manually. Alternatively, some or all data may be automatically derived from a reading image using various computer vision and machine learning techniques, leaving out the need for their definition in a template configuration.

Non-limiting examples of automatically derived data comprise: a gauge pivot point, computed, for example, by finding a point where the tick marks, if extended, would converge; gauge angles and values, computed, for example, using tick-mark detection and OCR (optical character recognition). In embodiments where all data may be automatically derived, a template configuration may be derived from a reading image by utilizing known or assumed properties of the image to either verify that the image is at a straight-on angle perspective, or to transform the image so that it appears to be from a straight-on angle. In some embodiments, some or all of the listed data may be omitted from the template if it may be assumed or otherwise computed directly from a reading image.

Data which may be collected to aid in gauge-reading includes any of the following without limitation. a) The location of a gauge within a template image, which may be defined using a bounding box, or a segmentation mask, or some other method apparent to one of skill in the art. This may be accomplished via manual tagging or automated using a machine learning algorithm or other computer vision algorithm. b) Optionally, a Boolean pixel mask indicating the areas of a gauge face which will be static and in the same plane. Such areas may be used for lining up templates and reading images. These areas comprise, without limitation, tick marks, labels, brand names, unit markings, manufacturer details, and other information printed or etched into the tick mark plate of a gauge. A needle, in particular, is not included in this region. Additionally, any regions outside of the gauge are excluded. Additional features to be excluded comprise bubble lines on liquid-filled gauges, sharp shadows, protruding screws or other fasteners, pins to limit needle movement, and markings on glass overtop a gauge. c) A pivot point of a needle. d) A main color(s) of a needle, and a main color(s) of a background over which a needle may be found. In a case of multiple needles, the colors for the needle to be read are indicated as needle colors, whereas colors of the needle to be ignored are indicated as background colors. Separate templates may be used to read each needle in turn. e) One or more parameters related to the thickness and length of the needle which may be used to increase reading accuracy by indicating how wide or narrow the needle should be expected to be. f) An innermost and an outermost radius which one uses to measure a needle direction, as measured from the needle pivot point. g) A reference angle, against which other directions may be measured. h) Angles of a minimum and maximum value on a gauge metric scale, along with the measurement values. i) Other angles and measurement values may be defined as well, which is important for cases where the gauge scale is non-linear, or if there is uncertainty in the exact position of the pivot point. “Non-linear” refers to a case where the relationship between needle angle and measurement value cannot be completely described with a linear interpolation between the minimum and maximum values. j) The height of a needle above a tick plate to increase accuracy of a parallax correction step. k) Additional metadata, including, for example, a gauge name, manufacturer, model number, units, user creating a template, template creation date, revision number, or other information available or introduced later.

According to some embodiments, a system is provided enabling a user to create a template configuration for use in a method for enhanced reading of an analog gauge. A computer-user interface preferably comprises a display of a template image (possibly enhanced or transformed) with manipulable elements, instructions, and feedback on the templating process. In some embodiments a user may modify and set any or all parameters, or a processor may automatically calculate some or all parameters. Automatic calculation with optional user adjustment is also contemplated. In one embodiment comprising a cloud-based implementation of a gauge templating program, a user is able to request templating assistance.

According to some embodiments, once gauge template data is produced, it may be moved to whatever device needs it, either as a file, an entry in a database, or as another form of data storage. Guage template data may also be stored in a central “library,” from which other users may be able to locate a suitable existing template configuration for a gauge they wish to read. Data may be uploaded to such a repository, downloaded to a user's computer, or otherwise transmitted to where it is needed.

In some methods and systems comprising creating template configurations, it is contemplated that a computer may execute software for evaluating the quality of a template, evaluating the readability of a gauge, or in an effort to determine some of the data described herein. According to one specific embodiment, determining optimal gauge template parameters comprises running gauge reading software iteratively or running a portion of the gauge reading software with various values of the template parameters and finding which values produce optimal confidence. For example, parameters related to the length and width of the needle may be varied as the gauge reading algorithm is run to find optimal parameters for identifying the needle.

According to some embodiments, systems for creating a gauge reading image comprise an image-capturing device, such as a camera, and a processing device/computer capable of running/executing gauge reading software. The image-capturing device and the computer do not need to be connected, although they may be connected. It is within the scope of the inventive methods to collect images using one device (a handheld camera, robotic-mounted camera, fixed-mounted camera, e.g.) and then transmit the image data to a computer. According to other embodiments, one or more image-capturing devices and a computer are co-located or are part of a single device.

According to some embodiments, an image of a target gauge(s) is provided as an input to gauge reading software, optionally along with other parameters, for example metadata including but not limited to an identifier for the target gauge, values for tunable parameters used by the reading software, a timestamp, a “normal range” for the gauge to indicate which readings are normal and which are anomalous, an indication of how multiple gauges may be arranged so they may be uniquely identified, data about the operation of a mobile robotics unit capturing the image, camera data including direction, exposure, shutter speed, etc., an identifier for which template(s) to use, or in specific embodiments, the templates themselves.

According to some embodiments, any gauges in an image are detected using a machine-learning computer vision algorithm. The algorithm may be trained on images of gauges, or other objects which may serve as analogues for gauges, or on synthetically generated images made to look like gauges, or any combination of these. An algorithm may use a convolutional neural network, or some other related architecture, along with additional data transformations, to predict the positions of analog gauges. These positions may be provided as bounding box coordinates, segmentation masks, or another suitable output method.

According to embodiments where a gauge can be reasonably expected to be in a reliable position in the image (with fixed-mounted cameras, for example), the gauge detection step may be skipped in favor of a static bounding box, or simply by having the gauge take up most of the image. In other embodiments alternatives to deep learning algorithms may also be used for gauge detection, including but not limited to circle detection through Hough transformation methods for circular gauges. Other options include using OCR, barcode, QR Code, or similar techniques to indicate where a gauge should be located in the image.

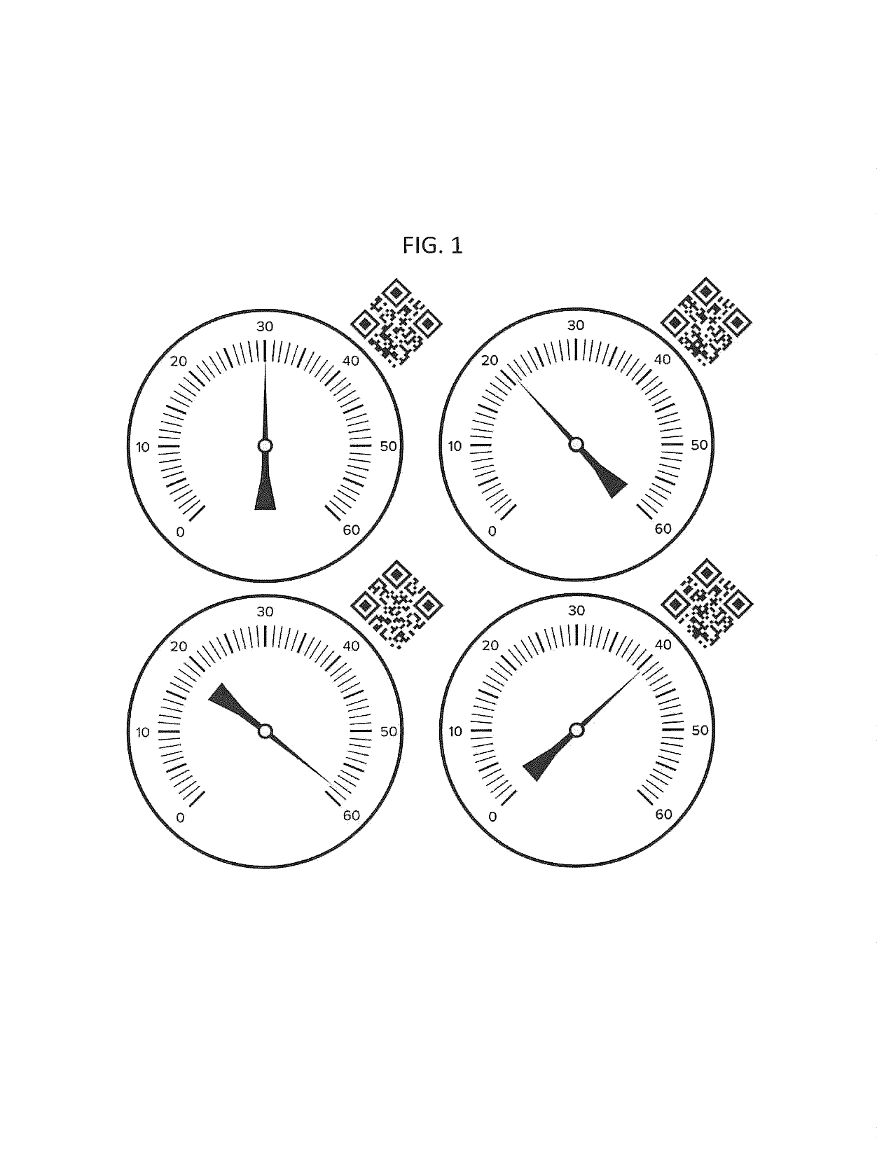

According to specific embodiments where multiple gauges are either expected, detected, or both in the image, an additional step is necessary to determine which gauge is which. This gauge identification may be achieved using one or more of the following:
i. QR codes, barcodes, distinctive patterns, color-coding, text, or other identifiers may be placed near the gauges to be read. The data encoded in these markers may uniquely identify the gauge and its characteristics, or it may serve as a key to look up the gauge and its characteristics in a database. Gauges may be identified based on the data in the nearest marker to its center or to a specified corner of the gauge. See FIG. 1.
ii. Each area of an image identified as a gauge may be compared with the gauge area of one or more template images. The set of template images to search through may be narrowed down by one or more factors, such as the set of gauge templates expected to be encountered in that area, or the particular step of an automated mission, or some metadata provided to gauge reading software. Similarity scores may be computed between every template image and a detected gauge, using a feature-based algorithm (such as SIFT (Scale Invariant Feature Transform) or SURF (Speeded up robust feature)), or a neural-network based technique, including CLIP encoding (Open AI) or a Siamese network, or OCR methods comparing text on the gauge faces. Expected and detected gauges can be matched by selecting the pairs with the best similarity scores, and continuing iteratively, or by selecting the mapping which produces the best sum of similarity scores. Additional rules, such as a lookup table or database indicating which gauges are expected to appear with other ones, may also be utilized to augment this method.
iii. A description of an expected gauge layout may be included in the metadata given to the software along with a reading image. This description may include expected location coordinates of each gauge and/or expected sizes of each gauge, and/or other location descriptors, such as “Top Left”, “Middle Center”, “Top Right”, etc. This description may be easily used to match expected and detected gauges, potentially with transforms to account for scale, rotation, or perspective differences between a location layout and a reading image. With this, a template for each gauge may be identified and used for an enhanced reading.

With each gauge identified, a reading image is correctly labeled when it is transmitted into logs or databases or notifications afterwards. Optionally, in specific embodiments where the reading image is used to automatically generate a template, that step could occur here, so each detected gauge will have an associated template.

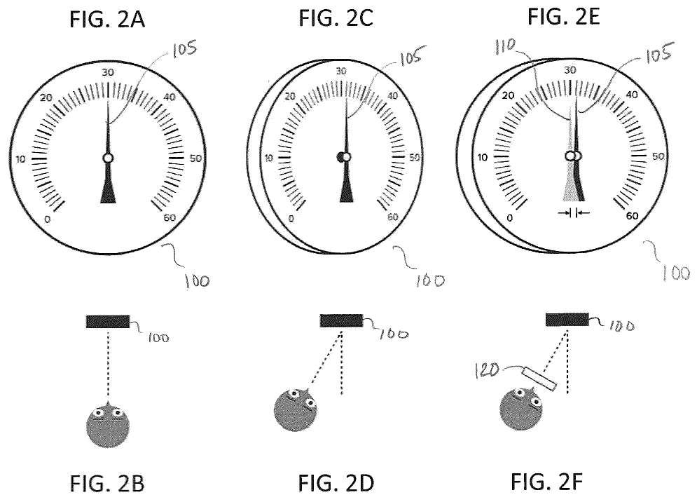

Each detected gauge may be read by one or more of the following procedures 1-12. The listed algorithms are readily available in computer vision libraries such as OpenCV familiar to those of ordinary skill in the art.
1. An image of a read gauge is cropped to an area of a detected gauge. Depending on the image quality and whether the feature-matching algorithm used is scale-invariant, an additional step of scaling the cropped reading gauge image to match the template size, or vice versa, may be necessary. Other image enhancement methods, including (but not limited to) gaussian blurring, Otsu thresholding, and contrast-limited adaptive histogram equalization (CLAHE) may also be employed.
2. A feature matching algorithm, such as SIFT, SURF, BRIEF, ORB, or others, may be used on both a template configuration and a reading image to identify features and to produce descriptors for them. The features in these images may be matched together using one of several available algorithms, for example, brute force and Fast Library for Approximate Nearest Neighbors (FLANN). Based on matches, a homography matrix is computed using, for example, random sample consensus or another similarly suitable method. The homography matrix is used to produce a perspective transformation, transforming the perspective of the reading gauge to that of the template gauge. Typically, only features in the same plane as tick marks and allowed features will be properly transformed, whereas objects out of that plane (including the gauge needle) may be offset from how they would naturally appear from this perspective. Additional feature locations and descriptions may be calculated using optical character recognition (OCR) software, associating positions of text (including value labels, units and branding) between the reading and template images. This may be utilized on its own or in conjunction with feature matchers to create the set of point correspondences used to calculate a homography matrix.
3. In some embodiments, properties of a perspective transformation are used to estimate a reading accuracy confidence. The properties may include simple matrix properties such as a determinant, and/or computed properties, such as the degree to which angles are widened or narrowed on simple geometric shapes (like squares) when the perspective transformation is applied. Very small, or negative determinants of the homography matrix may indicate problems with the perspective transformation, and large changes to angles upon transformation may also indicate problems. The scaling between the reading and template images, largely a function of image resolution, may affect these quantities, and should be accounted for.
4. From a homography (transformation) matrix, the perspective of the reading image is estimated. The calculation will depend on the camera lens, zoom, focus, and other properties. An exemplary method for calculating the perspective (an angle theta from the normal, and an angle phi azimuthally around the normal) is to consider a set of test points, transform them using the homography matrix, and then use the original and transformed coordinates in a perspective-n-point (PnP) computation. This perspective shift (see FIGS. 2A-2F) allows one to predict how the gauge needle will be offset in the transformed reading image. Thus, the needle pivot projected straight down to the tick plate will be exactly at the same coordinates as in the template image, but the pivot point where it intersects the needle will be offset by an amount and direction which can be estimated. Undoing this offset (see FIG. 2E) allows for a more accurate reading. There may be some ambiguity between offsets in opposite directions, so some of the following steps may need to be repeated assuming several different candidate pivot-on-needle positions. The direction of the offset is relatively easy to estimate accurately, though the magnitude (including sign) of the offset is harder to estimate, necessitating multiple iterations using different pivot-on-needle positions. Referring to FIGS. 2A-2F, a parallax correction according to embodiments of the invention is depicted. FIG. 2A illustrates a gauge 100 having a needle 105 as viewed from a straight-on angle perspective. FIG. 2B illustrates (viewed from above) an observer reading a gauge 100 from a straight-on angle perspective. FIG. 2C illustrates the same gauge 100 having a needle 105 as viewed from an angle. FIG. 2D illustrates (viewed from above) an observer reading the gauge 100 from an angle. FIG. 2E illustrates the gauge 100 having a needle 105 with a parallax-corrected needle 110 determined by methods according to the invention. FIG. 2F illustrates an embodiment (viewed from above) wherein an observer using a device comprising a camera 120 reading the gauge 100 from an angle such that the reading may be corrected.
5. For each pivot-on-needle position, a polar transformation is performed on the image. That is, transform the image into one where axis (typically the y-axis) is radial, and the other (typically the x-axis) is azimuthal. In this case, the pivot point of the needle should be at the top of the image, and the needle should be pointing straight down at some x-position.
6. For each of these polar transformations, a color transformation may be applied (based on the template) so that the needle is as dark as possible, and the background is as light as possible. This may be done with a color mapping algorithm which identifies colors as “needle-like” or “background-like” based on their proximity in RGB-space or HSV-space or some other color space to a set of expected template colors. The transformed colors may be related to the distance between a pixel's color and its nearest needle and/or background template color. This color transformation step is especially important for gauges with multiple needles of different colors, as this allows needles of different colors to be distinguished.
7. After inversion, the grayscale color-transformed image may be converted into a 1-D dataset, with each point representing the mean brightness of a column of pixels. Each of these columns corresponds to a needle direction. Inner and outer radii from a template configuration may be used to limit the data to a useful range.
8. For each of these 1-D configurations, standard peak-finding algorithms may be applied to find the most likely direction of the needle. The width and length of the needle may be used to adjust the metric used to determine the optimal peak in the 1-D data. Exemplary metrics comprise (peak prominence)\hat{ }(n)/(peak width), for a variety of values of n, for example ranging from ½ to 3.
9. The quality of each found peak may be estimated based on the overall prominence, and/or the ratio of the best peak metric to the second-best peak metric. Higher ratios indicate higher confidence.
10. The best peak, among all found peaks on all 1-D datasets from all pivot positions, indicates the position of the pivot-on-needle, and the direction of the needle.
11. While the perspective transformation will distort the needle by offsetting its position relative to the tick-plate, it will, to first order, not modify the angle of the needle. Thus, the position and direction of the needle, as it would appear if the gauge were viewed straight-on, can be accurately estimated. This perspective correction allows for more accurate readings than would be otherwise possible from gauge readings which are not straight-on. As taking a single straight-on image for the template is often much easier than lining up a camera for frequent inspections, this yields more accurate readings and lower cost than methods which simply rely on seeing where the needle tip lies between the tick marks. See FIG. 2A-2F. In some embodiments, especially where a template image is not produced from a true straight-on image, the parallax correction step may be omitted.
12. The measured angle of a needle is compared to known angles (and their values) from the template, and, using linear interpolation, splines, or another interpolation method, the value to which the gauge needle points is computed.

Notably, the above methods are successful even when a reading image has deficiencies. Partially obscured gauges, including cases when the needle or tick labels are partially obscured, may still be successfully read, provided enough of the needle and gauge markings are still visible. Correction for parallax error as described above is not impeded by out-of-focus images or unusual gauges, as the template already encodes the information which may be difficult to discern from a poor reading image of a gauge.

Steps for detecting a needle direction (steps 5-12) may be replaced with other suitable techniques known generally to one skilled in the art. Potential alternatives include Hough transformation to find lines, a template matching algorithm to detect a rotated needle, traditional contour-finding or neural-network-assisted image segmentation, iteratively finding the longest straight line from within identified segments, or some combination of these methods and/or other similar methods.

### Reading Uncertainty/Confidence

As data points are far more valuable if their uncertainties are understood, according to some embodiments, a statistical uncertainty analysis, for example a 1-sigma gaussian uncertainty, may be performed on a reading, based on a potential angular uncertainty. This uncertainty may be estimated using many different techniques, including, but not limited to polynomial fit, random forest regression, Gradient Boosted Decision trees, multi-layer perceptron, and combinations thereof. In specific embodiments, an uncertainty estimator is fitted based on a large dataset of gauge images, with appropriate templates, and known true readings. The optimization then involves minimizing the difference between the estimator output and the angular reading error, averaged over all samples. Inputs to these estimators comprise any combination of image resolutions, number of key points and/or features which line up after a perspective transformation, properties of the homography matrix, for example determinant, properties of the perspective transformation, for example how angles or sides of a square are distorted upon transformation, absolute prominence of a needle peak in a transformed polar image's 1-D configuration, peak quality metric of a found needle, and ratio of a peak quality metric to a second-best peak.

Similarly, a confidence estimate (to indicate whether the reading is, as a whole, trustworthy), is computed in a similar manner. In some embodiments a reading is considered trustworthy if the true value lies within the 1-sigma uncertainty, 2-sigma uncertainty, or some other desired range. In some specific embodiments a confidence estimate is computed within a certain angular range, for example as within 2°, 3°, 4°, 5° or any suitable range of a true direction. The confidence estimator may then be fitted using the same methods (fitting over a large sample set) as set forth for an uncertainty estimator. An estimated uncertainty may now be an input to a confidence estimator. A confidence can be calibrated to represent the probability that the reading is “trustworthy/accurate”, or some modified version of that, to meet the end-user's expectations for what a confidence score should indicate.

Alternatively, confidence may be computed first and used to compute uncertainty.

### Model Outputs

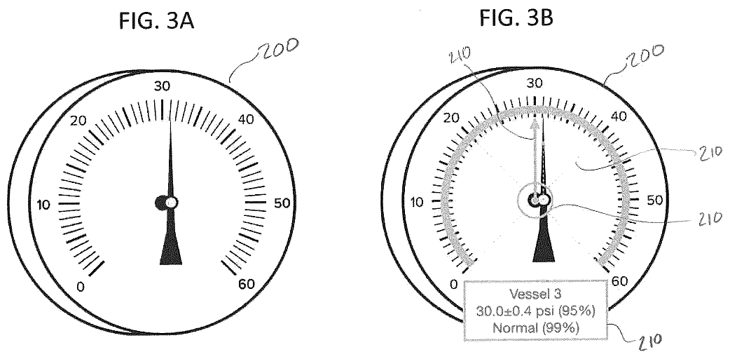

An output from a gauge reading may comprise:
An annotated version of a transformed reading image. This image is cropped to relatively near the gauge, and will, via the transformation described above, appear to be roughly “straight-on”, possibly except for objects not in the tick-mark plane. Annotations may comprise an indication of the found line of the true needle, and an indication of where the needle would be if truly observed from straight-on (that is, the parallax corrected needle position). Tick marks, values/directions, the reading, its uncertainty, confidence, and/or whether the reading falls within the normal range for this gauge may also be annotated. See FIGS. 3A-3B, wherein annotations 210 to the transformed gauge image 200 are shown.
An annotated version of an input image, indicating (by bounding box or other method) the location of the gauge(s) being read. This may also comprise annotations showing what those readings are, their uncertainties and confidences, and/or whether these readings fall within the expected normal range for these gauges. An overlay may also be shown over the gauge showing additional annotations to demonstrate how the reading worked. This may simply be the annotations drawn on the transformed/cropped gauge image, transformed back (using the inverse of the homography matrix) from the transformed image to the reading image.
The reading itself, and its uncertainty.
Reading confidence.
Confidence that the reading is within the normal range for the gauge (assuming gaussian or similar error distribution).
Other metadata useful for understanding the reading, or for identifying the gauge being measured.

### EXAMPLES

The following examples are given by way of illustration are not intended to limit the scope of the disclosure.

### Example 1. Implementation of Template and Reading Image Procedures

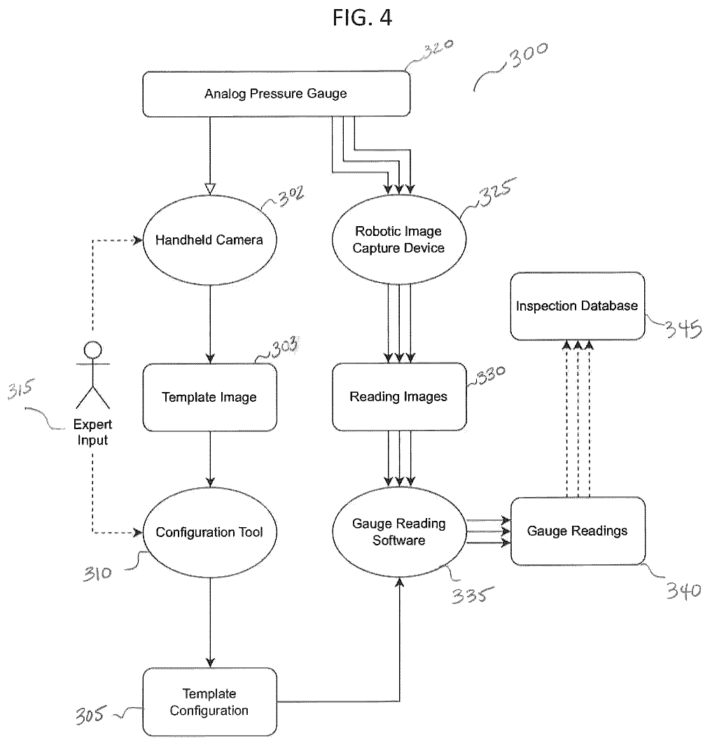

FIG. 4 shows a high-level example of how a method 300 is implemented using a robotic image capture device 325. First, a camera 302 is used to generate a template image 303. A template configuration is created at block 305 using a configuration tool 310, with input from a subject-matter expert 315. The created template configuration 305 is used repeatedly to conduct readings on a gauge 320. An analog pressure gauge 320 is exemplified, although it should be appreciated that any analog gauge may be used in the method. A robotic image capture device 325 (for example, a robotic dog or other suitable image capture device) automatically captures reading images at block 330 of the gauge on a regular schedule. The template configuration 305 is applied to the reading images 330 through gauge reading software at block 335, which outputs corrected gauge readings at block 340. These regular gauge readings 340 are transmitted to a database of inspection results at block 345.

### Example 2. Creation of Template Configuration

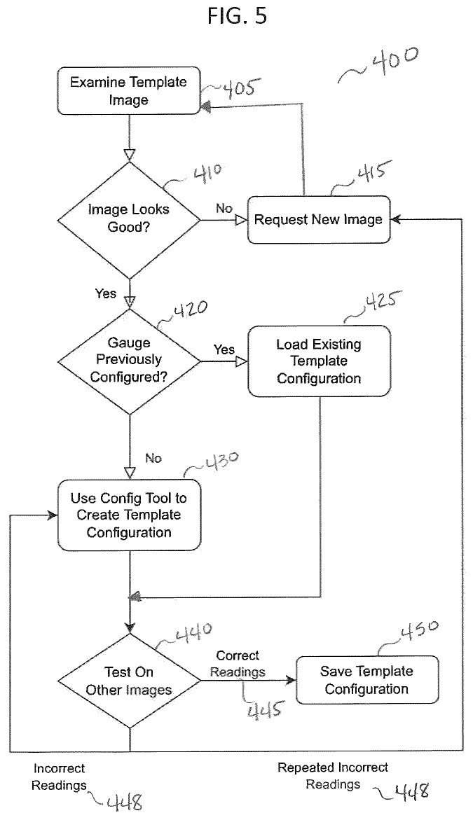

FIG. 5 depicts method 400 for obtaining a template image, creating a template configuration, and testing the created template configuration.

At block 405, a template image is examined. If the template image does not meet quality expectations and is not considered good at block 410, the process moves to block 415 where a new image is requested. The process then returns to block 405.

If the image meets quality expectations and is considered good at block 410, the process moves to block 420 where it is determined whether or not the gauge was previously configured. If the gauge was previously configured at block 420, the process moves to block 425 where the existing template configuration is loaded. From there, the process moves to block 440, which is described below.

If the gauge was not previously configured at block 420, the process moves to block 430 where a configuration tool is used to create a template configuration. The process then moves to block 440 where a test is run on other images. If correct readings 445 result from block 440, the template configuration is saved at block 450. If incorrect readings 448 result from block 440, the process moves back to block 430, where the configuration tool is used to update the configuration. If the incorrect readings 448 persist after multiple cycles of configuration 430 and testing 440, a new image is requested at block 415.

### Example 3. System Enabling Creation of a Template Configuration

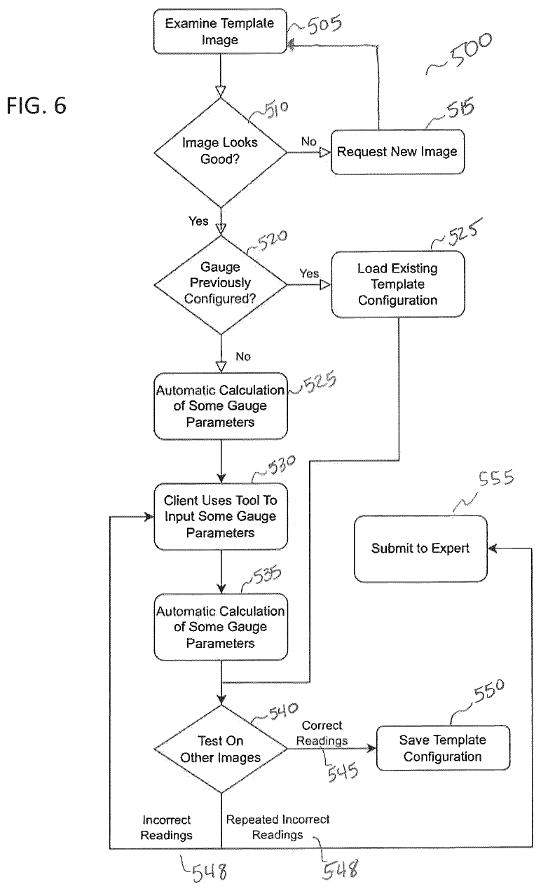

FIG. 6 depicts a method 500 wherein a user of a specific system embodiment obtains a gauge template configuration by primarily automated methods.

At block 505, a template image is examined. If the template image does not meet quality expectation and is not considered to look good at block 510, the process moves to block 515 where a new image is requested. The process then returns to block 505.

If the image meets quality expectations and is considered to look good at block 510, the process moves to block 520 where it is determined whether or not the gauge was previously configured. If the gauge was previously configured at block 520, the process moves to block 525 where the existing template configuration is loaded. From there, the process moves to block 540, which is described below.

If the gauge was not previously configured at block 520, an automatic calculation of some gauge parameters is performed at block 525. Then, the client uses a tool to input some additional gauge parameters at block 530. At block 535 there are automatic calculation(s) of some additional gauge parameters. At block 540, the configuration is tested on other images. If there are correct readings 545, the template configuration is saved at block 550. If there are incorrect readings 548, the process moves to block 530 where the client uses the tool to input other parameters. If incorrect readings 548 persist after multiple cycles of using the tool 530, the repeated incorrect readings 548 will lead to block 555, where the process is submitted to an expert to handle.

### Example 4. Automatic Templating

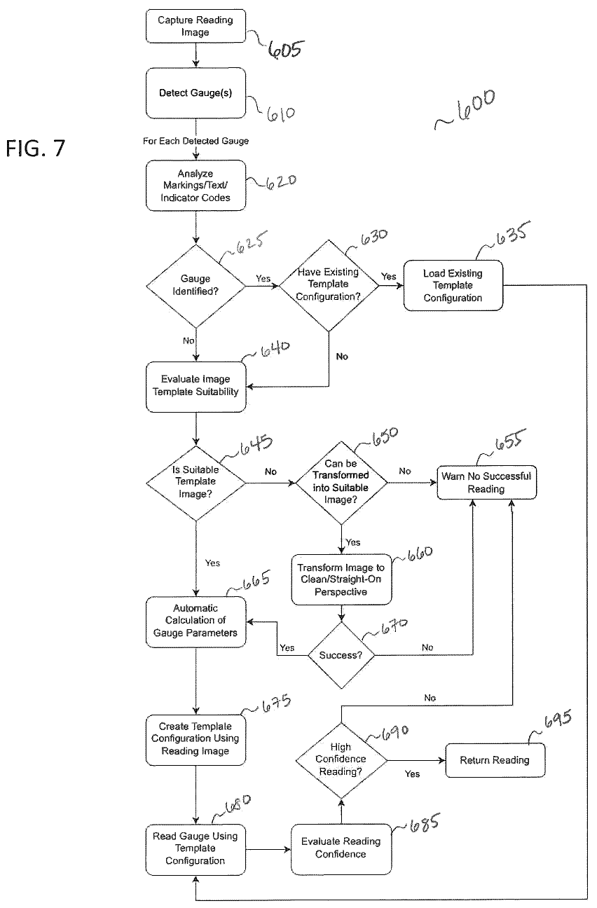

FIG. 7 depicts a method 600 for generating acceptably accurate gauge readings without requiring a target gauge to have had a template configuration of it previously obtained or created. Methods are automatically run at reading time with no user-intervention required.

At block 605 a reading image is captured. At block 610 the gauge is detected. The markings, text, and/or indicator codes are analyzed at block 620 for each detected gauge. If a gauge is identified at block 625, the process moves to block 630 where it is determined whether or not the gauge has a template configuration. If the answer is yes at block 630, the process moves to block 635 where an existing template configuration is loaded. The existing template configuration is then provided to block 680, which is described in more detail below.

If no gauge is identified at block 625 or there is no existing template configuration at block 630, the process moves to block 640 where the suitability of the reading image as a template image is evaluated. If the image is suitable at block 645, the process moves to 665. If the template image is not suitable at block 645, the process moves to block 650 where it is determined if the template image can be transformed into a suitable image. If the answer is no at block 650, a warning of no successful reading is provided at block 655. If the template image can be transformed into suitable images, the image is transformed into clean/straight-on perspective at block 660. If the transformation is not successful at block 670, a warning of no successful reading is provided at block 655. If there is a success at block 670, the process moves to block 665.

At block 665 there is an automatic calculation of gauge parameters. The process then moves to block 675 where a template configuration is created using the reading image. At block 680 the gauge is read using the template configuration. At block 685 the reading confidence of block 680 is evaluated. If there is a high confidence reading at block 690, a reading is returned at block 695. If there is not a high confidence reading at block 690, a warning of no successful reading is generated at block 655.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. The term “substantially” is used herein also to represent the degree by which a quantitative representation may vary from a stated reference without resulting in a change in the basic function of the subject matter at issue. Thus, it is used to represent the inherent degree of uncertainty that may be attributed to any quantitative comparison, value, measurement, or other representation, referring to an arrangement of elements or features that, while in theory would be expected to exhibit exact correspondence or behavior, may in practice embody something less than exact.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” or “including” a second component, it is contemplated that, in some embodiments, the first component “consists” or “consists essentially of” the second component. Additionally, the term “consisting essentially of” is used in this disclosure to refer to quantitative values that do not materially affect the basic and novel characteristic(s) of the disclosure.

It should be understood that any two quantitative values assigned to a property or measurement may constitute a range of that property or measurement, and all combinations of ranges formed from all stated quantitative values of a given property or measurement are contemplated in this disclosure.

While particular embodiments have been illustrated and described herein, it should be understood that various other changes and modifications may be made without departing from scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

We claim:

1. A method for enhanced automated reading of an analog gauge, the method comprising:
obtaining a reading image of a target gauge,
obtaining or creating a template configuration corresponding to the target gauge, processing the reading image relative to the corresponding template configuration, determining any irregularity in the reading image, and
compensating for the determined irregularity.

2. The method according to claim 1, wherein processing the reading image comprises computing a transform on the reading image.

3. The method according to claim 2, wherein the transform comprises a homographic transform.

4. The method according to claim 1, wherein the determined irregularity comprises a parallax error.

5. The method according to claim 1, wherein the step of determining any irregularity comprises processing data from the template configuration and a transformed reading image.

6. The method according to claim 1, wherein the step of compensating for the determined irregularity comprises estimating one or more of a corrected reading, an uncertainty on the corrected reading, and a confidence value for the corrected reading.

7. The method according to claim 1, further comprising adding data and/or metadata associated with the target image to the template configuration.

8. The method according to claim 1, wherein obtaining a reading image comprises capturing an image of the target gauge with one or more image-capturing devices.

9. The method according to claim 8, wherein one or more image-capturing devices comprises a digital camera.

10. The method according to claim 7, wherein one or more image-capturing devices is mounted on a robotic unit.

11. The method according to claim 10, wherein the robotic unit comprises a mobile robotic unit.

12. A system for creating a template configuration for use in enhancing an automated reading of a target gauge value, the system comprising:
a computer comprising a computer-user interface,
a template image of a target gauge accessible to a user at the interface, wherein the template image comprises associated data,
a computer-executable algorithm for a set of queries prompting the user to enter input data at the interface, and
a computer-executable algorithm for creating a template configuration from the associated data and the input data.

13. The system according to claim 12, wherein the associated data comprises input data.

14. The system according to claim 12 further comprising a database comprising one or more stored and accessible template images.

15. The system according to claim 12 further comprising a database structured to receive and store created template configurations.

16. The system according to claim 12 further comprising a computer-executable algorithm for determining reliability of a created template configuration.

17. A system for processing a read image for use in enhancing an automated reading of a target gauge value, the system comprising:
at least one image-capturing device positioned to capture at least one reading image of a target gauge,
a computer for receiving a captured image of a target gauge,
a database comprising accessible template configurations, and
a computer-executable algorithm for processing a reading image of a target gauge relative to its corresponding template configuration,
wherein the processing determines any irregularities in the reading image.

18. The system according to claim 17 wherein the processing further comprises compensating for any determined irregularities in the reading image to yield a corrected reading value.

19. The system according to claim 18, wherein the processing further comprises estimating a corrected reading value, an uncertainty on a corrected reading value, and a confidence value for a corrected reading value.
